(19) United States
(12) Patent Application Publication
(10) Pub. No.: US 2024/0308878 A1
(43) Pub. Date: Sep. 19, 2024

(54) WATER TREATMENT SYSTEM, WATER TREATMENT METHOD, AND AMINE SOLUTION

(71) Applicant: KABUSHIKI KAISHA TOSHIBA, Tokyo (JP)

(72) Inventors: Akiko SUZUKI, Ota (JP); Yoshihiko NAKANO, Yokohama (JP); Reiko YOSHIMURA, Kawasaki (JP)

(73) Assignee: KABUSHIKI KAISHA TOSHIBA, Tokyo (JP)

(21) Appl. No.: 18/464,323

(22) Filed: Sep. 11, 2023

(30) Foreign Application Priority Data
Mar. 16, 2023 (JP) 2023-042424

(51) Int. Cl. C02F 1/04; C02F 1/54; C02F 9/00

(52) U.S. Cl. CPC C02F 1/042; C02F 1/54; C02F 9/00; C02F 2305/00

(57) ABSTRACT

A water treatment system according to an embodiment includes an element that introduces treated water into a first container, an element that introduces an amine solution into the first container to obtain a first mixture, an element that separates a supernatant phase and a concentrated phase of a second mixture in which the first mixture is phase-separated. The amine solution includes one or more tertiary amine compounds represented by a chemical formula (1) or/and a chemical formula (2). R¹ in the chemical formula (1) is a linear alkyl chain having 2 or more and 4 or less carbon atoms. R² in the chemical formula (2) is a linear alkyl chain having 2 or more and 4 or less carbon atoms. R³ in the chemical formula (2) is a linear alkyl group having 1 or more and 4 or less carbon atoms or a branched alkyl group having 3 or 4 carbon atoms. R⁴ in the chemical formula (2) is a linear alkyl group having 1 or more and 4 or less carbon atoms or a branched alkyl group having 3 or 4 carbon atoms.

### CROSS-REFERENCE TO RELATED APPLICATION

This application is based upon and claims the benefit of priority from Japanese Patent Application No. 2023-42424, the Filing Date of which is Mar. 16, 2023, the entire contents of which are incorporated herein by reference.

### FIELD

Embodiments described herein relate generally to a water treatment system, a water treatment method, and an amine solution.

### BACKGROUND

As the global population increases, the demand for water is expected to grow significantly, and low-energy desalination technologies are in demand. There are several popular desalination methods, including the thermal evaporation method and the reverse osmosis membrane (RO membrane) method, and in recent years the RO membrane method, which consumes relatively little energy, has been widely put into practical use. The reverse osmosis membrane method desalinates by applying pressure in the opposite direction of osmotic pressure to the osmotic membrane.

### BRIEF DESCRIPTION OF THE DRAWINGS

FIG. 1 is a schematic diagram of a water treatment system according to an embodiment.

FIG. 2 is a flowchart of a water treatment method.

FIG. 3 shows chemical formulas of a tertiary amine compound according to an embodiment.

FIG. 4 is shows chemical formulas of a tertiary amine compound according to an embodiment.

FIG. 5 is a schematic diagram of a water treatment system according to an embodiment.

FIG. 6 is a flowchart of a water treatment method.

FIG. 7 is a schematic diagram of a water treatment system according to an embodiment.

FIG. 8 is a flowchart of a water treatment method.

### DETAILED DESCRIPTION

A water treatment system according to an embodiment includes an element that introduces treated water into a first container, an element that introduces an amine solution into the first container to obtain a first mixture, an element that separates a supernatant phase and a concentrated phase of a second mixture in which the first mixture is phase-separated. The amine solution includes one or more tertiary amine compounds represented by a chemical formula (1) or/and a chemical formula (2). R¹ in the chemical formula (1) is a linear alkyl chain having 2 or more and 4 or less carbon atoms. R² in the chemical formula (2) is a linear alkyl chain having 2 or more and 4 or less carbon atoms. R³ in the chemical formula (2) is a linear alkyl group having 1 or more and 4 or less carbon atoms or a branched alkyl group having 3 or 4 carbon atoms. R⁴ in the chemical formula (2) is a linear alkyl group having 1 or more and 4 or less carbon atoms or a branched alkyl group having 3 or 4 carbon atoms.

Hereinafter, the embodiments of the invention will be described with reference to the drawings. Unless otherwise noted, values obtained by pH and other measurements are those measured at 25° C., under atmospheric pressure.

Water treatment of embodiments relates to the concentration recovery (including extraction) and/or generation of water (e.g., desalination) from water of the target material.

### First Embodiment

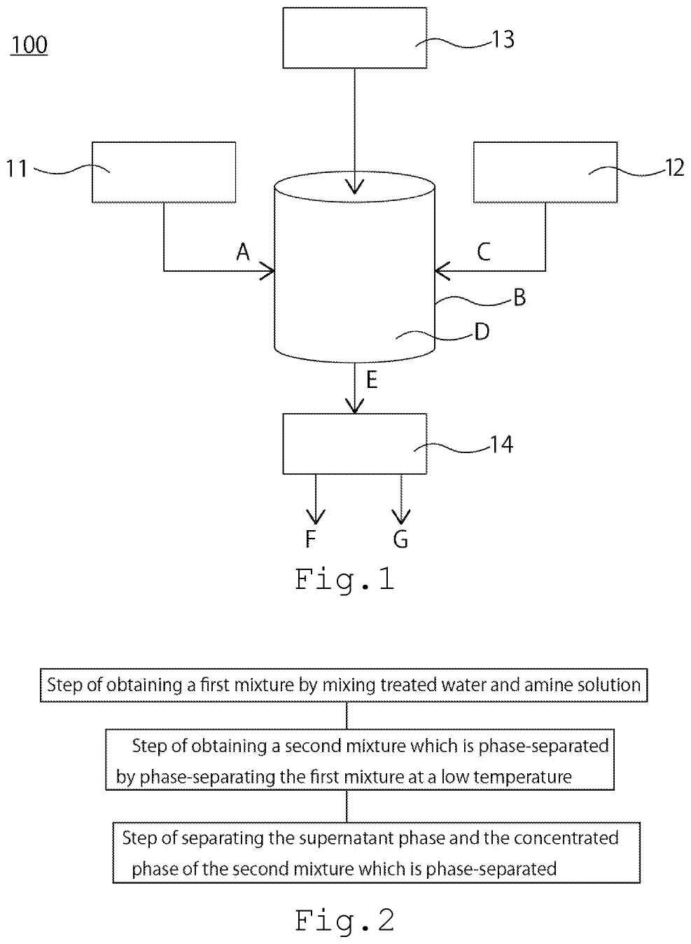

A first embodiment relates to a water treatment system and a water treatment for non-evaporation extraction separation by concentration using a tertiary amine compound whose hydrophobicity and hydrophilicity changes with respect to temperature. FIG. 1 shows a schematic diagram of a water treatment system 100 of the first embodiment. The schematic diagram of the water treatment system 100 in FIG. 1 includes an element 11 that introduces treated water A into a first container B, an element 12 that introduces an amine solution C into the first container B to obtain a first mixture D, an element 13 that controls the temperature, and an element 14 that separates a supernatant phase F (liquid phase) and a concentrated phase G (liquid, solid or slurry phase) of a second mixture E in which the first mixture D containing the treated water A and the amine solution C is phase-separated. The second mixture E is phase-separated at low temperatures.

In the schematic diagram of FIG. 1, the element 11 that introduces the treated water A into the first container B, the element 12 that introduces the amine solution C into the first container B to obtain the first mixture D, the element 13 that controls the temperature, and the element 14 that separates the supernatant phase F and the concentrated phase G of the second mixture E in which the first mixture D containing the treated water A and the amine solution C is phase-separated are provided outside the first container B, but these elements may be provided inside the first vessel B.

FIG. 2 shows a flowchart of the water treatment method of the first embodiment. The water treatment method of the embodiment preferably includes obtaining a first mixture D by mixing the treated water A and the amine solution C, obtaining a second mixture E which is phase-separated by separating the first mixture D at a low temperature, and separating the supernatant phase F and the concentrated phase G of the second mixture E which is phase-separated. The process of mixing the treated water A and the amine solution C to obtain the first mixture D is performed by the element 11 that introduces the treated water A into the first container B and the element 12 that introduces the amine solution C into the first container B to obtain the first mixture D. By storing the first mixture D at low temperature in the first container B, the first mixture D is phase-separated, and the second mixture E, which is phase-separated, is obtained. The first container B, in which the treated water A and the amine solution C are mixed, and the container containing the first mixture D when the first mixture D is phase-separated can be the same container or different containers. The separating the supernatant phase F and the concentrated phase G of the second mixture E which is phase-separated is performed by the element 13 that controls the temperature and the element 14 that separates the supernatant phase F and the concentrated phase G of the second mixture E in which the first mixture D containing the treated water A and the amine solution C is phase-separated. Hereinafter, the water treatment system 100 will be described, but the description of the water treatment system 100 also includes a description of the water treatment method.

The element 11 that introduces the treated water A into the first container B introduces the treated water A into the first container B. the element 11 that introduces the treated water A into the first container B is equipped with, for example, piping leading to the first vessel B, water quality measuring instruments such as pH meters, conductivity meters, etc., thermometers, and valves, cocks and pumps to control the flow rate of the treated water A through the piping as instruments to ascertain the properties of the treated water A.

The treated water A includes water and inorganic salts having solubility in water and/or organic substances having solubility in water. The inorganic salt having solubility in water and/or the organic substance having solubility in water are separated by the water treatment system 100 of the embodiment. The inorganic salts and/or the organic substances in the treated water A can be separated by phase separation. The separated inorganic salts and/or the organic substances may be recovered. The inorganic salt is dissolved in treated water A, and the inorganic salt is present in treated water A as ions. When the organic substance is a water-soluble salt, the treated water A includes the ionized organic substance and the counter ions of the ionized organic substance. The organic substance included in the treated water A (organic substance to be recovered by extraction) is preferably a compound that is water soluble and solid or liquid at the treatment temperature. Treatment of the treated water A can be carried out even if the treated water A contains practically no salt and only organic substance. When only “treated water A” is written, it represents the treated water A before the water treatment in the embodiment.

The treated water A is an aqueous solution. The total mass of the inorganic salts and/or the organic substances and water is preferably 5 [wt %] or more and 300 [wt %] or less of the water in the treated water A. The treated water A may include 0.0 [wt %] or more and 5 [wt %] or less of one or more kinds selected from the group consisting of an organic material insoluble in water, an organic material that is water soluble and liquid at the treatment temperature, metal, and metal oxide in addition to the inorganic salt and/or the organic substance and the water.

The concentration of the inorganic salts and/or the organic substances included in the treated water A is not particularly limited. In the embodiment, the inorganic salts and/or the organic substances can be separated regardless of the concentration of the inorganic salts and/or the organic substances contained in the treated water A.

The ions included in the treated water A are specifically one or more kind selected from the group consisting of sodium ion, potassium ion, lithium ion, magnesium ion, calcium ion, manganese ion, iron ion, fluoride ion, sulfate ion, nitrate ion, nitrite ion, chloride ion, bromide ion, iodide ion, cyanide ion, acetate ion, hydrogen carbonate ion, thiocyanate ion, hydrogen sulfide ion, hydrogenoxalate ion, chlorate ion, hyperchloric acid ion, hydroxide ion, silver ion, copper ion, iron ion, cobalt ion, tin ion, lead ion, ammonium ion, aluminum ion, chromium ion, various complex ions, phosphate ion, strontium ion, barium ion, cadmium ion, nickel ion, zinc ion, mercury ion, ionic silica, and more. Non-ionized organic material, silica, and colloidal silica may be also included in the treated water A.

The first container B is a container for the treated water A and the amine solution C. The element 11 that introduces the treated water A into the first container B, the element 12 that introduces the amine solution C into the first container B to obtain the first mixture D, the element 13 that controls the temperature, and the element 14 that separates the supernatant phase F and the concentrated phase G is preferably provided in the first container B. The element 14 that separates the supernatant phase F and the concentrated phase G can be installed in a different container than the first container B.

The total pressure in the first container B is preferably 700 [Pa] or more and 1 [MP] or less. The gases in the first container B include carbon dioxide, argon, oxygen, and nitrogen. Part of the gas in the first container B is included in one or more selected from the group consisting of the treated water A, the amine solution C, the first mixture D, the second mixture E, and the supernatant phase F.

The element 12 that introduces the amine solution C into the first container B to obtain the first mixture D introduces the amine solution C into the first container B. The element 12 that introduces the amine solution C into the first container B to obtain the first mixture D is equipped with, for example, piping leading to the first container B, and instruments to determine the properties of the amine solution C, such as a pH meter, conductivity meter, thermometer, and valves, cocks, and pumps to control the flow rate of the amine solution C through the piping.

The element 13 that controls the temperature can adjust the temperature of the treated water A, the first container B, the amine solution C, the first mixture D, the phase-separated second mixture E, the supernatant phase F and the concentrated phase G. Temperature adjustment by the element 13 that controls the temperature is not performed when not needed. The element 13 that controls the temperature is a heat medium such as a heater or hot water and/or a coolant medium such as a cooling coil or atmosphere (air-cooled). It is preferable to use waste heat as the element 13 that controls the temperature.

The temperature of the first mixture D in the first container B with or without the element 13 that controls the temperature is preferably 3[° C.] or more and 40[° C.] or less. If the temperature of the first mixture D is too low, it may require more energy for cooling or the viscosity of the solution may increase, making it difficult to handle. If the temperature of the first mixture D is too high, more energy may be required for heating, the amine compound may volatilize, and each phase may be difficult to form. The temperature of the first mixture D is more preferably 5[° C.] or more and 35[° C.] or less. By maintaining the first mixture D and the phase-separated second mixture E at the above low temperature, the concentrated phase G can be recovered.

The amine solution C includes a tertiary amine whose solubility changes in response to temperature. The solution including the amine solution C changes its liquidity in response to the temperature in the solution. When the amine solution C is mixed with the treated water A at low temperature, the solute contained in the treated water A educts or the water containing the solute contained in the treated water A separates from the amine.

The tertiary amine compound used in the embodiment are liquid at room temperature (25[° C.]).

When the tertiary amine compound used in the embodiment is mixed with water, it forms a homogeneous phase with water or separates into an aqueous phase and an organic phase, depending on the temperature. In the first embodiment, water treatment is performed by utilizing the property of the tertiary amine compound used to easily incorporate water at low temperatures. In the second and subsequent embodiments, the reuse of the tertiary amine compound will be described using their property of separating into the aqueous phase and the organic phase at high temperatures. A compound with a low boiling point gives off a characteristic ammonia odor, so a compound with a high boiling point is more preferably used. Phase-separability varies among compounds, and some compound dissolve to some extent in water even at high temperatures. A compound with high phase-separability that do not dissolve easily in water at high temperatures is more desirable because the amount of the amine compound in the supernatant phase F increases when the amine compound that easily dissolve in water is used. The use of the amine compound with high solubility at room temperature, high boiling point and high phase-separability at elevated temperatures allow for efficient separation. The amine compound that allows efficient extraction operations to be performed with small amount of the amine compound.

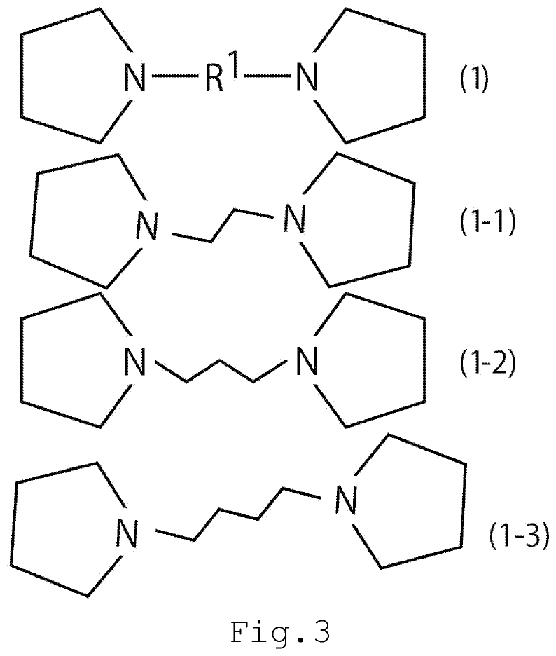

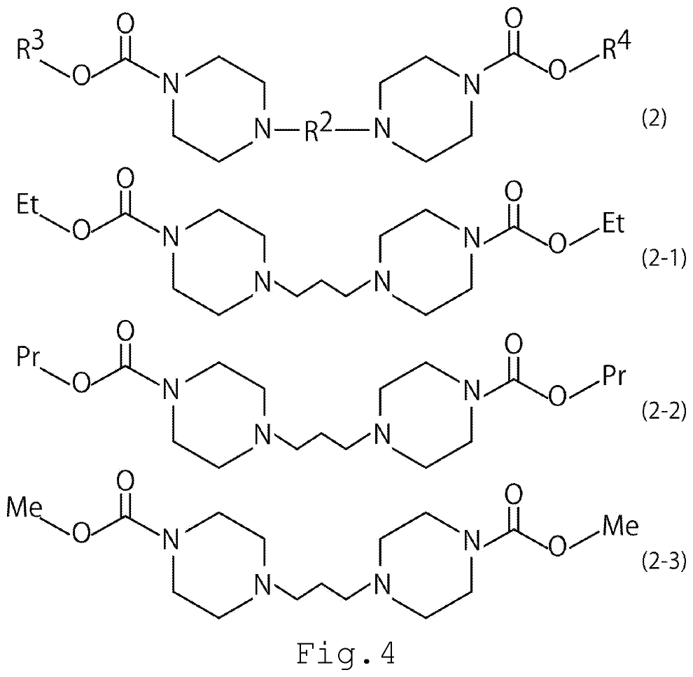

FIG. 3 and FIG. 4 show the chemical formulas of the tertiary amine compounds of the embodiments. The amine solution C preferably includes one or more tertiary amine compounds represented by a chemical formula (1) or/and a chemical formula (2) shown in FIG. 3 and FIG. 4. It is preferable that the amine solution C include tertiary amine compound represented by the chemical formula (1) or the chemical formula (2) shown in FIG. 3 and FIG. 4. It is preferable that the amine solution C include the tertiary amine compounds represented by the chemical formula (1) and the chemical formula (2) shown in FIG. 3 and FIG. 4. The tertiary amine compound represented by the chemical formula (1) or the chemical formula (2) may be described as amine compound of the embodiment. The amine compound of the embodiment is highly compatible with water at low temperatures. Because of their high compatibility with water, a large amount of the amine compound of the embodiment are dissolved in water. When the amine compound of the embodiment is dissolved in 7 times the volume or more of the amine compound of the embodiment to water, the substance dissolved in the treated water A becomes less soluble in the treated water A. The substance that can no longer dissolve in the treated water A becomes the concentrated phase G. The amine compound of the embodiment becomes less compatible with water when heated. The concentrated phase G in the second mixture E is maintained at a low temperature. The separation of the concentrated phase G and the supernatant phase F is maintained at a low temperature. The supernatant phase F of the embodiment is phase-separated when heated. When heated, the solution including the amine compound of the embodiment changes its liquid properties because the solution exceeds the lower critical solution temperature of the amine compound. The first embodiment takes advantage of the high compatibility of the amine compound of the first embodiment with water at low temperatures.

The amine compound of the embodiment has a high dissolution rate in water, so the concentrated phase G appears rapidly. The rapidly appearing concentrated phase G improves the work efficiency of water treatment. The amine compound of the embodiment is difficult to volatilize during water treatment due to its high vapor pressure at 25° C.

The concentrated phase G appears even when a relatively low amount of the amine compound of the embodiment is used. This means that the amount of the amine compound of the embodiment required to obtain the concentrated phase G may be low. By virtue of using the amine compound of the embodiment, the utilization efficiency of the amine compound of the embodiment used to obtain the concentrated phase G becomes high.

The vapor pressure of the amine compound of the embodiment at 25[° C.] is preferably 1.0×10⁻¹⁰ [Torr] or more and 1.0×10⁻¹ [Torr] or less.

When water treatment is performed at 10[° C.], it is confirmed that the amine compound of the embodiment has a high solubility with the treated water A and the concentrated phase G is appeared.

From the viewpoint of high solubility at room temperature, high boiling point and high phase-separation at heating, R¹ in the chemical formula (1) is preferably a linear alkyl chain having 2 or more and 4 or less carbon atoms. R¹ of the chemical formula (1) is preferably a linear alkyl chain having 2 or 3 carbon atoms. It is preferred that R¹ of the chemical formula (1) is a linear alkyl chain having 3 carbon atoms.

From the viewpoint of high solubility at room temperature, high boiling point and high phase-separation at heating, R² in the chemical formula (2) is preferably a linear alkyl chain having 2 or more and 4 or less carbon atoms.

From the viewpoint of high solubility at room temperature, high boiling point and high phase-separation at heating, R³ in the chemical formula (2) is preferably a linear alkyl group having 1 or more and 4 or less carbon atoms or a branched alkyl group having 3 or 4 carbon atoms.

From the viewpoint of high solubility at room temperature, high boiling point and high phase-separation at heating, R⁴ in the chemical formula (2) is preferably a linear alkyl group having 1 or more and 4 or less carbon atoms or a branched alkyl group having 3 or 4 carbon atoms.

It is preferred that R² in the chemical formula (2) is a linear alkyl chain having 2 or more and 4 or less carbon atoms, and R³ and R⁴ are the same and are linear alkyl groups each having 1 or more and 4 or less carbon atoms or branched alkyl groups each having 3 or 4 carbon atoms.

It is preferred that R² in the chemical formula (2) is a linear alkyl chain having 2 or 3 carbon atoms, and R³ and R⁴ are the same and are linear alkyl groups each having 1 or more and 3 or less carbon atoms or branched alkyl groups each having 3 to 4 carbon atoms.

It is preferred that R² in the chemical formula (2) is a linear alkyl chain having 2 or 3 carbon atoms, and R³ and R⁴ are the same and are linear alkyl groups each having 1 or more and 3 or less carbon atoms or branched alkyl groups each having 3 carbon atoms.

It is preferred that R² of the chemical formula (2) is a linear alkyl chain having 3 carbon atoms, and R³ and R⁴ are the same, linear alkyl groups each having 1 or more and 3 or less carbon atoms.

It is preferred that R² in the chemical formula (2) is a linear alkyl chain having 3 carbon atoms, and R³ and R⁴ are the same and are linear alkyl groups each having 1 carbon atom.

It is preferred that R² in the chemical formula (2) is a linear alkyl chain having 3 carbon atoms, and R³ and R⁴ are the same and are linear alkyl groups each having 2 carbon atoms.

It is preferred that R² in the chemical formula (2) is a linear alkyl chain with 3 carbon atoms, and R³ and R⁴ are the same and are linear alkyl groups having 3 carbon atoms.

It is preferred that the amine solution C includes 80 [wt %] or more and 100 [wt %] or less of the tertiary amine compound whose solubility changes in response to temperature. It is more preferred that the amine solution C includes 90 [wt %] or more and 100 [wt %] or less of the tertiary amine compound whose solubility changes in response to temperature. It is even more preferred that the amine solution C includes 95 [wt %] or more and 100 [wt %] or less of the tertiary amine compound whose solubility changes in response to temperature.

It is preferred that the amine solution C includes 80 [wt %] or more and 100 [wt %] or less of the tertiary amine compound of the chemical formula (1) or/and the chemical formula (2) in total. It is more preferred that the amine solution C includes 90 [wt %] or more and 100 [wt %] or less of the tertiary amine compound of the chemical formula (1) or/and the chemical formula (2) in total. It is even more preferred that the amine solution C includes 95 [wt %] or more and 100 [wt %] or less of the tertiary amine compound of the chemical formula (1) or/and the chemical formula (2) in total.

It is preferred that the amine solution C includes 80 [wt %] or more and 100 [wt %] or less of the tertiary amine compound of the chemical formula (1) or the chemical formula (2). It is more preferred that the amine solution C includes 90 [wt %] or more and 100 [wt %] or less of the tertiary amine compound of the chemical formula (1) or the chemical formula (2). It is even more preferred that the amine solution C includes 95 [wt %] or more and 100 [wt %] or less of the tertiary amine compound of the chemical formula (1) or the chemical formula (2).

It is preferred that the tertiary amine compounds of the embodiment have high solubility in water. Because the tertiary amine compounds of the embodiment have high solubility, the time required for phase-separation can be shortened. By reducing the time required for phase-separation, the treatment rate of the treated water A can be increased, and the high solubility also contributes to the recovery rate because the tertiary amine compounds dissolve in water (treated water), which causes phase-separation from slurry containing high concentration of solutes or extraction of solutes.

It is preferred that the solubility of the tertiary amine compounds of the embodiment be 35 [g/L] or more. The upper limit of solubility is not limited, but for example, the solubility of the tertiary amine compounds of the embodiment should be 1000 [g/L] or less.

Diisopropylamine, propylbutylamine, dibutylamine, 2-ethylhexylamine, N-ethylbenzylamine, heptylamine, and octylamine can also be used for phase-separation. However, the high boiling point and vapor pressure of these amine compounds make them impractical because of solvent loss and odor.

It is preferred that the tertiary amine compounds of the embodiment have a high boiling point. The tertiary amine compounds with low boiling points are easily volatilized. Because amines have a distinctive odor, it is preferable to use amines that are less likely to volatilize for water treatment. It is also preferable to use tertiary amine compounds that are less likely to volatilize, which increases the efficiency of amine recovery, which will be explained in the second and subsequent embodiments.

The boiling point of the tertiary amine compound of the embodiment at 1 atm is preferably 100[° C.] or more, more preferably 150[° C.] or more, and even more preferably 200[° C.] or more. The upper limit of boiling point is not particularly limited, but the boiling point of the tertiary amine compound of the embodiment at 1 atm is, for example, 500[° C.] or less.

Diisopropylamine, propylbutylamine, dibutylamine, 2-ethylhexylamine, N-ethylbenzylamine, heptylamine, and octylamine can also be used for phase-separation. However, these amine compounds have boiling points below 200[° C.] and vapor pressures as high as 1 Torr or more at room temperature. These amines are not practical because of their solvent loss and odor.

It is preferable to use an appropriate amount of the amine solution C according to the amount of the inorganic salts and/or the organic substances included in the treated water A, because a small amount of the amine solution C causes a small amount of the inorganic salts and/or the organic substances included in the treated water A to educt out. The total number of moles of the tertiary amine compounds whose solubility changes with temperature is preferably equal to or more of the total number of moles of the inorganic salts and/or the organic substances contained in the treated water A. The total number of moles of the tertiary amine compounds whose solubility changes with temperature is more preferably two times or more of the total number of moles of the inorganic salts and/or the organic substances contained in the treated water A. The total number of moles of the tertiary amine compounds whose solubility changes with temperature is even more preferably five times or more of the total number of moles of the inorganic salts and/or the organic substances contained in the treated water A.

Hydrogen may be omitted from the chemical formula. For example, if three of the four bonds of carbon are shown in the chemical formulas in FIG. 3 and FIG. 4, one of the remaining bonds of carbon is a bond to hydrogen, and the bond to hydrogen is omitted. For example, the ethyl group may be abbreviated as Et. The propyl group may be abbreviated as Pr. Methyl groups may be abbreviated as Me. Other similar abbreviations are included in the specification.

A specific example of an amine compound of the chemical formula (1) is shown in FIG. 3. The synthesis of compounds of the chemical formula (1) will be briefly described. For example, pyrrolidine and 1,3-dibromopropane (other dibromomethane and 1,2-dibromoethane are used depending on the carbon number of the alkyl chain) are heated and stirred in a solvent, and pyrrolidine to the bromine on both sides of 1,3-dibromopropane by nucleophilic reaction. The resulting compound can be purified to obtain the tertiary amine of the chemical formula (1).

It is preferable that one or more compounds selected from the group consisting of a tertiary amine compound of the chemical formula (1-1), a tertiary amine compound of the chemical formula (1-2) and, a tertiary amine compound of the chemical formula (1-3) as the amine compound of the chemical formula (1).

The tertiary amine compound of the chemical formula (1-1) in FIG. 3 is a compound with high solubility at room temperature, high boiling point and low vapor pressure at room temperature, and high phase-separation when heated. The tertiary amine compound of the chemical formula (1-1) has a high vapor pressure at 25[° C.]. When water treatment is performed using the tertiary amine compound of the chemical formula (1-1) at 10[° C.], the concentrated phase G appears. Since the lower critical solution temperature of the chemical formula (1-1) is included in the range of 35[° C.] or more and 90[° C.] or less, the amine can be regenerated after the second embodiment by mild heating.

When amine solution C including 50 [wt %] or more of the tertiary amine compound of the chemical formula (1-1) is used, the temperature of the first mixture D and the temperature of the second mixture E are preferably below the room temperature at the place where the invention is carried out, and are preferably 5[° C.] or more to 38 [° C.] or less. If the temperature is carried out at or more than room temperature, the temperature will be lower than that of the first container in an un-tempered area of the equipment, and solids may be extracted from the second mixture E and liquid phase F, and the piping may be blocked.

The tertiary amine compound of the chemical formula (1-2) in FIG. 3 is a compound with high solubility at room temperature, high boiling point and high phase-separation when heated. The tertiary amine compound of the chemical formula (1-2) has a high vapor pressure at 25[° C.]. When water treatment is performed using the tertiary amine compound of the chemical formula (1-2) at 10[° C.], the concentrated phase G appears. Since the lower critical solution temperature of the chemical formula (1-2) is included in the range of 35[° C.] or more or 90[° C.] or less, the amine can be regenerated after the second embodiment by mild heating.

When the amine solution C including 50 [wt %] or more of the tertiary amine compound of the chemical formula (1-2) is used, the temperature of the first mixture D and the temperature of the second mixture E are preferably 5[° C.] or more and 38[° C.] or less.

The tertiary amine compound of the chemical formula (1-3) in FIG. 3 is a compound with high solubility at room temperature, high boiling point, and high phase-separation when heated. The tertiary amine compound of the chemical formula (1-3) has a high vapor pressure at 25[° C.]. When water treatment is performed using the tertiary amine compounds of chemical formula (1-3) at 10[° C.], a concentrated phase G appears. Since the lower critical solution temperature of the chemical formula (1-3) is included in the range of 35[° C.] or more or 90[° C.], the amine can be regenerated after the second embodiment by mild heating.

When the amine solution C including 50 [wt %] or more of the tertiary amine compound of the chemical formula (1-3) is used, the temperature of the first mixture D and the temperature of the second mixture E are preferably 5[° C.] or more and 38[° C.] or less.

A specific example of an amine compound of the chemical formula (2) is shown in FIG. 4. The synthesis of compounds of the chemical formula (2) will be briefly described. For example, methyl-1-piperadinecarboxylate and 1,3-dibromopropane (other dibromomethane and 1,2-dibromoethane are used depending on the carbon number of the alkyl chain) are heated and stirred in a solvent, and methyl-1-piperadinecarboxylate to the bromine on both sides of 1,3-dibromopropane by nucleophilic reaction. The resulting compound can be purified to obtain the tertiary amine of the chemical formula (2).

It is preferable that one or more compounds selected from the group consisting of a tertiary amine compound of the chemical formula (2-1), a tertiary amine compound of the chemical formula (2-2), and a tertiary amine compound of the chemical formula (2-3) as the amine compound of the chemical formula (2).

The tertiary amine compound of the chemical formula (2-1) in FIG. 4 is a compound with high solubility at room temperature, high boiling point and high phase-separation when heated. The tertiary amine compound of the chemical formula (2-1) has a high vapor pressure at 25[° C.]. When water treatment is performed using the tertiary amine compounds of chemical formula (2-1) at 10[° C.], a concentrated phase G appears. Since the lower critical solution temperature of the chemical formula (2-1) is included in the range of 35[° C.] or more or 90[° C.], the amine can be regenerated after the second embodiment by mild heating.

When the amine solution C including 50 [wt %] or more of the tertiary amine compound of the chemical formula (2-1) is used, the temperature of the first mixture D and the temperature of the second mixture E are preferably 5[° C.] or more and 38[° C.] or less.

The tertiary amine compound of the chemical formula (2-2) in FIG. 4 is a compound with high solubility at room temperature, high boiling point and high phase-separation when heated. The tertiary amine compound of the chemical formula (2-2) has a high vapor pressure at 25[° C.]. When water treatment is performed using the tertiary amine compounds of chemical formula (2-2) at 10[° C.], a concentrated phase G appears. Since the lower critical solution temperature of the chemical formula (2-2) is included in the range of 35[° C.] or more or 90[° C.], the amine can be regenerated after the second embodiment by mild heating.

When the amine solution C including 50 [wt %] or more of the tertiary amine compound of the chemical formula (2-2) is used, the temperature of the first mixture D and the temperature of the second mixture E are preferably 5[° C.] or more and 38[° C.] or less.

The tertiary amine compound of the chemical formula (2-3) in FIG. 4 is a compound with high solubility at room temperature, high boiling point and high phase-separation when heated. The tertiary amine compound of the chemical formula (2-3) has a high vapor pressure at 25[° C.]. When water treatment is performed using the tertiary amine compounds of chemical formula (2-3) at 10[° C.], a concentrated phase G appears. Since the lower critical solution temperature of the chemical formula (2-3) is included in the range of 35[° C.] or more or 90[° C.], the amine can be regenerated after the second embodiment by mild heating.

When the amine solution C including 50 [wt %] or more of the tertiary amine compound of the chemical formula (2-3) is used, the temperature of the first mixture D and the temperature of the second mixture E are preferably 5[° C.] or more and 38[° C.] or less.

The supernatant phase F is a mixture of the treated water A and the amine solution C from which solute and solvent (in the case of slurry) have been partially removed. When the temperature is increased, the liquid nature of the amine solution C changes from hydrophilic to hydrophobic. When the supernatant phase F is heated, the amine solution C separates into an amine-rich phase and a water-rich phase due to the LCST (Lower Critical Solution Temperature) phenomenon. Then, the tertiary amine compounds included in the amine solution C can be reused.

The first mixture D including the treated water A and the amine solution C is contained in the first container B.

In the embodiment, water treatment is performed using the treated water A and amine solution described above. In the embodiment, the inorganic salts and/or the organic substances included in the treated water A are separated (concentrated) by the water treatment of the embodiment.

A pH (measured at 25[° C.]) of the treated A water is preferably 6 or more and 13 or less, and more preferably 10 or more and 12 or less. If the pH of the first mixture D is less than 6, it is undesirable because the alkaline amines are likely to form salts, dissolve in the water, and become unrecoverable. If the pH of the treated water A is greater than 13, it is undesirable because the equipment is more likely to corrode. it is preferable to use an alkaline solution to adjust the pH. The alkaline solution used to adjust the pH is preferably selected from the group consisting of sodium hydroxide, potassium hydroxide, potassium carbonate, and sodium hydrogen carbonate. To adjust the pH of the first mixture D, it is preferable to adjust the pH of the treated water A.

The treated water A and the amine solution C are mixed to obtain the first mixture D. During mixing, the mixture may be stirred vigorously. With respect to the ratio of the treated water A to the amine solution C, where the volume of the treated water A is 1, the volume of the amine solution C (solvent/feed) is preferably 1 or more and 200 or less, more preferably 1 or more and 50 or less, and even more preferably 1 or more and 25 or less. With respect to the ratio of the treated water A to the amine solution C, where the volume of the treated water A is 1, the volume of the amine solution C (solvent/feed) is preferably 4 or more and 200 or less, more preferably 4 or more and 50 or less, and even more preferably 4 or more and 25 or less. With respect to the ratio of the treated water A to the amine solution C, where the volume of the treated water A is 1, the volume of the amine solution C (solvent/feed) is preferably 7 or more and 100 or less, more preferably 7 or more and 50 or less, and even more preferably 7 or more and 25 or less. High efficiency of amine utilization is desirable by using fewer amine compounds for separation. With respect to the ratio of the treated water A to the amine solution C, where the volume of the treated water A is 1, the volume of the amine solution C can be carried out with 4 or more and 20 or less, or 4 or more and 15 or less.

By placing the first mixture D including the treated water A and the amine solution C contained in the first container B in a low-temperature environment, the first mixture D is phase-separated and separated into the supernatant phase F and the concentrated phase G. The phase of the first mixture D separates at preferably 3[° C.] or more and 40[° C.] or less, more preferably 5[° C.] or more and 35[° C.] or less. It is also desirable to let the first mixture D be static in the first container B for 5 minutes or more and 3 hours or less or to mechanically insert a separation operation using the density difference between the supernatant phase F and the concentrated phase G until the supernatant phase F and the concentrated phase G are separated (the time during which the first mixture D is phase-separated). If the first mixture D is heated at this stage, the salt solubility in the supernatant phase F will increase and the salt concentration in the concentrated phase G will decrease.

When the treated water A is mixed with the amine solution C, the tertiary amine compounds dissolve in the treated water A, which makes the inorganic salts and/or the organic substances dissolved in the treated water A less soluble, and the inorganic salts and/or the organic substances are more easily concentrated. The phase separation here enables the inorganic salts and/or the organic substances to be concentrated without using the nature of the polarity conversion.

The second mixture E, which is phase-separated, includes the supernatant phase F and the concentrated phase G. The concentrated phase G in the second mixture E which is phase-separated is an extracted member consisting of extractions or a liquid containing solutes in high concentrations. If the supernatant phase F and the concentrated phase G are not sufficiently separated, the phase-separated second mixture E may be stirred, amine solution C may be added, it may be cooled, or the first mixture D phase-separated second mixture E may be centrifuged.

The element 14 that separates the supernatant phase F and the concentrated phase G separates the supernatant phase F and the concentrated phase G. The element 14 that separates the supernatant phase F and the concentrated phase G includes a mechanism to drain either or both the supernatant phase F and the concentrated phase G from the second mixture E from which the first mixture D is phase-separated from the first container B. As the element 14 that separates the supernatant phase F and the concentrated phase G, for example, a pump that extracts the supernatant phase F from the upper side of container B can be used. As the element 14 that separates the supernatant phase F and the concentrated phase G, a filter through which the concentrated phase G is filtered at the bottom of the first container B and an opening that can be controlled to open and close by a cock or other means can be used when the concentrated phase G is a solid extracted member (precipitation). The concentrated phase G remains in the filter and the supernatant phase F can be discharged through the opening to separate the supernatant phase F from the concentrated phase G. Then, the supernatant phase F and the concentrated phase G can be discharged separately from the first container B by collecting the concentrated phase G remaining on the filter. In addition, the second mixture E, from which the first mixture D is phase-separated, can be transferred to another container before separating the supernatant phase F and the concentrated phase G separately in a similar manner. The mesh size of the filter is appropriately selected according to the substances contained in the concentrated phase G.

The water treatment system 100 and water treatment method of the embodiment can efficiently separate the inorganic salts and/or the organic substances included in the treated water A by using the tertiary amine whose liquid nature changes in response to temperature. The water treatment system 100 and the water treatment method can efficiently recover the inorganic salts and/or the organic substances contained in the treated water A under low temperature conditions. This can be done at a very low energy compared to concentrating the treated water A by evaporating the water contained in the treated water A.

### Second Embodiment

A second embodiment relates to a water treatment system and a water treatment method applied to non-evaporative extraction separation by concentration using a tertiary amine compound that changes hydrophobicity and hydrophilicity in response to temperature. The second embodiment is an example that the first embodiment is applied. In the second embodiment, the water treatment is performed by utilizing the LCST (Lower Critical Solution Temperature) phenomenon of the tertiary amine compounds of the embodiment that are hydrophilic at low temperatures.

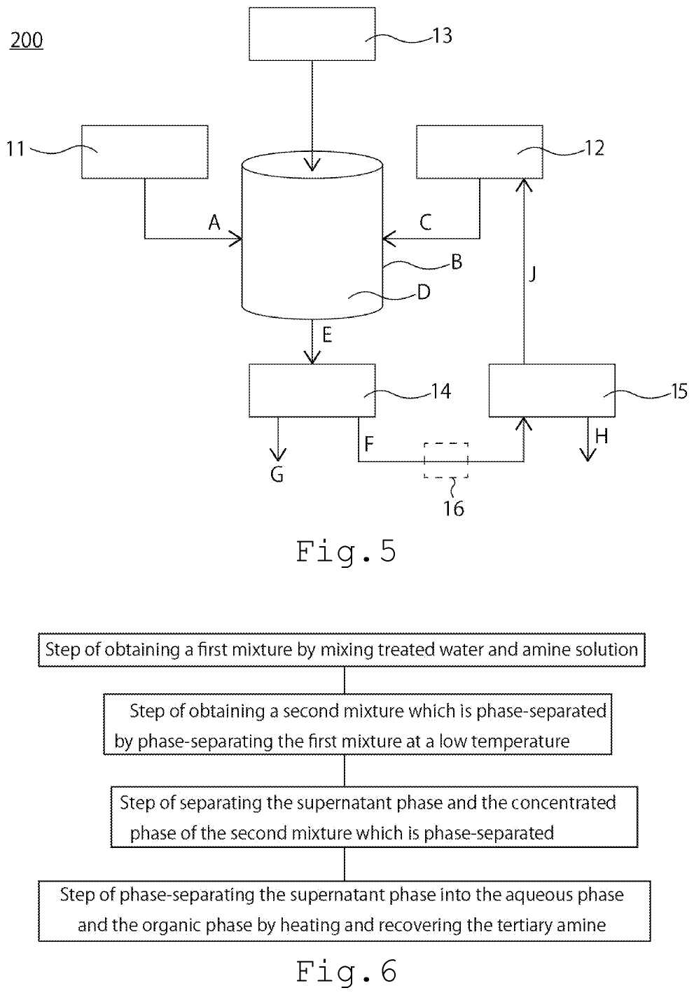

FIG. 5 shows a schematic diagram of the water treatment system 200 of the second embodiment. The water treatment system 200 of FIG. 5 includes the element 11 that introduces the treated water A into the first container B, the element 12 that introduces the amine solution C into the first container B to obtain the first mixture D, the element 13 that controls the temperature, the element 14 that separates the supernatant phase F and the concentrated phase G of the second mixture E in which the first mixture D containing the treated water A and the amine solution C is phase-separated, and an element 15 that separates the supernatant phase F into an aqueous phase H and an organic phase (amine phase) J and recovers the tertiary amine (organic phase J). A filter 20 is preferably provided between the element 14 that separates the supernatant phase F and the concentrated phase G and the element 15 recovering the tertiary amine. The mesh size of filter 16 is appropriately selected according to the material to be filtered.

The water treatment system 200 of the second embodiment is common to the water treatment system 100 of the first embodiment except that it has the element 15 that separates the supernatant phase F into the aqueous phase H and the organic phase (amine phase) J and recovers the tertiary amine (organic phase J) and the separated and recovered tertiary amine (organic phase J) is mixed with the amine solution C via the element 12 that introduces the amine solution C into the first container B to obtain the first mixture D. In the second embodiment, the description of the contents common to the first embodiment is omitted.

FIG. 6 shows a flowchart of the water treatment method of the second embodiment. The water treatment method of the embodiment preferably includes obtaining the first mixture D by mixing the treated water A and the amine solution C, obtaining the second mixture E which is phase-separated by separating the first mixture D at a low temperature, separating the supernatant phase F and the concentrated phase G of the second mixture E which is phase-separated, and separating the supernatant phase F into the aqueous phase H and the organic phase J by heating and recovering the tertiary amine. In the second embodiment, the separating the supernatant phase F into the aqueous phase H and the organic phase J and recovering the tertiary amine is performed by the element 15 that separates the supernatant phase F into the aqueous phase H and the organic phase J and recovers the tertiary amine. Hereinafter, the water treatment system 200 will be described, but the description of the water treatment system 200 also includes a description of the water treatment method.

The supernatant phase F, separated in the element 14 that separates the supernatant phase F and the concentrated phase G, is processed in the element 15 that separates the supernatant phase F into the aqueous phase H and the organic phase J and recovers the tertiary amine. The supernatant phase F is an aqueous solution in which the tertiary amine is dissolved. The supernatant phase F may include small amounts of the inorganic salts and/or the organic substances. The path from the element 14 that separates the supernatant phase F and the concentrated phase to the element 15 that recovers the tertiary amine compound is preferably provided with a filter 16. The supernatant phase F may include the inorganic salts and/or the organic substances in solid form that is partially extracted. A filter 16 is preferably provided to remove the solid inorganic salts and/or the organic substances in the supernatant phase F to reduce the solid inorganic salts and/or the organic substances flowing into the element 15 that separates the supernatant phase F into the aqueous phase H and the organic phase J and recovers the tertiary amine.

The element 15 that separates the supernatant phase F into the aqueous phase H and the organic phase J and recovers the tertiary amine recovers the tertiary amine included in the supernatant phase F. As the element 15 that separates the supernatant phase F into the aqueous phase H and the organic phase J and recovers the tertiary amine, the mechanism of heating the supernatant phase F is preferable. For example, the supernatant phase F is stored in a second container, not shown, and the supernatant phase F is heated in the second container. As the temperature of the supernatant phase F is increased, the compatibility of the tertiary amine compounds of the embodiment with water changes, and supernatant phase F separates into the organic phase and the aqueous phase. The supernatant phase F separates into the aqueous phase H and the organic phase J at a higher temperature than the first mixture D which separates into the phases. It is preferable that the supernatant phase F is heated to a temperature higher than the temperature of the first mixture (the temperature at which the first mixture D is phase-separated (the temperature at which the supernatant phase F and the concentrated phase G are separated separately)). It is preferable that the supernatant phase F is heated to a temperature 5[° C.] or higher than the temperature of the first mixture D (the temperature at which the first mixture D is phase-separated (the temperature at which the supernatant phase F and the concentrated phase G are separated separately)). It is preferable that the supernatant phase F is heated to a temperature 10[° C.] or higher than the temperature of the first mixture D (the temperature at which the first mixture D is phase-separated (the temperature at which the supernatant phase F and the concentrated phase G are separated separately)). It is preferable that the supernatant phase F is heated to a temperature 20[° C.] or higher than the temperature of the first mixture D (the temperature at which the first mixture D is phase-separated (the temperature at which the supernatant phase F and the concentrated phase G are separated separately)). It is preferable that the supernatant phase F is heated to a temperature 20 [° C.] or higher than the temperature of the first mixture D. It is preferable that the supernatant phase F is heated to a temperature 30 [° C.] or higher than the temperature of the first mixture D (the temperature at which the first mixture D is phase-separated (the temperature at which the supernatant phase F and the concentrated phase G are separated separately)). The supernatant phase F is preferably heated to 35[° C.] or more and less than 90[° C.]. From the viewpoint of reducing energy consumption, it is more preferably that the supernatant phase F is heated to 35[° C.] or more and 75[° C.] or less. The supernatant phase F is preferably phase-separated at 35 [° C.] or more and less than 90[° C.]. From the viewpoint of reducing energy consumption, the supernatant phase F is more preferably phase-separated at 35[° C.] or more and less than 90[° C.]. It is preferable to use waste heat generated at a plant or the like to heat the supernatant phase F.

When the supernatant phase F is heated, the compatibility between the tertiary amine compounds and water changes, and the supernatant phase F is phase-separated into aqueous phase H and organic phase J. The aqueous phase H contains tertiary amine compounds, the inorganic salts and/or the organic substances that are dissolved in water. The organic phase J includes tertiary amines whose compatibility with water changes in response to temperature, and the organic phase J is returned to the amine solution C to recycle the tertiary amine compounds whose compatibility with water changes in response to temperature.

From the viewpoint of recovering the tertiary amine from the supernatant phase F, it is preferable to use the tertiary amine included in the supernatant phase F, i.e., the amine compound of the embodiment included in the amine solution C.

The phase-separation of the supernatant phase F including the amine compound of the embodiment is confirmed at 90[° C.].

The tertiary amine compound in the amine solution C is more preferably the tertiary amine compound of the first embodiment shown in FIG. 3 and FIG. 4 from the two perspectives of recovering the tertiary amine from the supernatant phase F and extracting and separating the inorganic salts and/or the organic substances from the treated water A.

The water treatment system 200 and the water treatment method of the embodiment can recover amines from the supernatant phase F generated when the inorganic salts and/or the organic substances included in the treated water A are efficiently separated by using the tertiary amine whose liquid nature changes in response to temperature. In the water treatment system 200 and the water treatment method, the supernatant phase F can be mildly heated to separate the supernatant phase F to recover the amin used to extract the inorganic salts and/or the organic substances. This can be done at very low energy compared to concentrating the supernatant phase F by evaporating the water contained in the supernatant phase F. Thus, the water treatment system 200 can be performed with lower energy and lower environmental burden overall.

### Third Embodiment

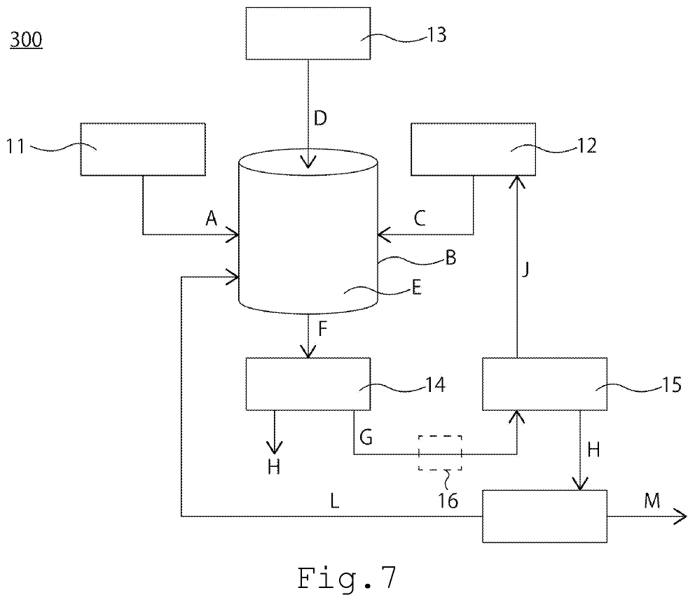

A third embodiment relates to a water treatment system and a water treatment method applied to non-evaporation extraction separation (desalination) by concentration using a tertiary amine compound that changes hydrophobicity and hydrophilicity in response to temperature. The third embodiment is an application of the first and second embodiments. FIG. 7 shows a schematic diagram of the water treatment system 300 of the third embodiment. The water treatment system of FIG. 7 includes the element 11 that introduces the treated water A into the first container B, the element 12 that introduces the amine solution C into the first container B to obtain the first mixture D, the element 13 that controls the temperature, the element 14 that separates the supernatant phase F and the concentrated phase G of the second mixture E in which the first mixture D containing the treated water A and the amine solution C is phase-separated, the element 15 that separates the supernatant phase F into the aqueous phase H and the organic phase (amine phase) J and recovers the tertiary amine (organic phase J), and an element 16 that treats the aqueous phase H with a RO membrane (reverse osmosis membrane). A NF membrane (nanofiltration membrane) may be used instead of the RO membrane depending on the properties of the amine molecules.

The water treatment system 300 of the third embodiment has elements 16 for treating the aqueous phase H with the RO membrane, the obtained highly purified water M is discharged, and the concentrated water L is returned to the first container B. Other than these, the system is common to the water treatment system 200 of the second embodiment. In the third embodiment, the description of the contents common to the second embodiment is omitted.

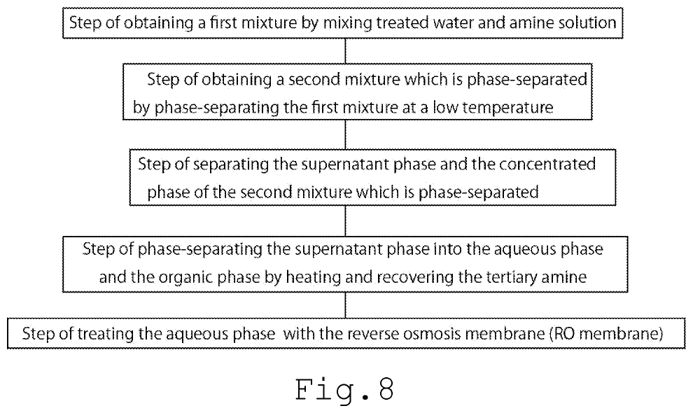

FIG. 8 shows a flowchart of the water treatment method of the third embodiment. The water treatment method of the embodiment preferably includes obtaining the first mixture D by mixing treated water A and amine solution C, obtaining the second mixture E which is phase-separated by separating the first mixture D at a low temperature, separating the supernatant phase F and the concentrated phase G of the second mixture E which is phase-separated, separating the supernatant phase F into the aqueous phase H and the organic phase J by heating and recovering the tertiary amine, and treating the aqueous phase H with the reverse osmosis membrane (RO membrane). The treating the aqueous phase H with the RO membrane is performed by the element 16 that treats the aqueous phase H with RO membrane. Hereinafter, the water treatment system 300 will be described, but the description of the water treatment system 300 also includes a description of the water treatment method.

The obtained highly purified water M includes almost no impurities because it has been treated with RO membranes, so it can be discharged into rivers and the like if the water quality conditions are met. If the treated water A is treated directly with the RO membrane, the power cost is very high. However, highly purified water L can be efficiently obtained by using RO membrane to treat aqueous phase H, which is much smaller in volume than treated water A.

A concentrated water L obtained by carrying out the treatment with the RO membrane is preferably returned to the first container B through a flow path provided for return, and is again concentrated and treated. The concentrated water L includes the tertiary amine included in the amine solution C, in addition to the inorganic salts and/or organic substances contained in the treated water A. Thus, the amount that can be recovered in the concentrated phase G is increased by the cyclical water treatment. In addition, the concentrated water L can be returned to the first container B through the element 11 that introduces the treated water A into the first container B. The concentrated water L can also be used as treated water in another water treatment without returning it to the first container B.

If the treated water A contains a high concentration of salt, the osmotic pressure of the treated water is large, and a general RO membrane treatment technology cannot be applied. In any of the embodiments, the water treatment system can treat even a high salt concentration in the treated water A, and highly purified water M can be obtained by finally treating the aqueous phase H with a low concentration by the RO membrane treatment.

In the water treatment system 300 and the water treatment method of the embodiment, the tertiary amine, which changes its liquid properties in response to temperature, is used to obtain the supernatant phase F generated when the inorganic salts and/or the organic substances contained in the treated water A are efficiently separated, and further to obtain the highly purified water M and concentrated water L by phase-separation of the supernatant phase F. The water treatment system 300 and the water treatment method can perform cyclical water treatment in which both the inorganic salts and/or organic substances in the concentrated phase G and the highly purified water M are separated from the treated water A. As described in the water treatment system 100 of the first embodiment and the water treatment system 200 of the second embodiment, the water treatment system 300 can be performed with low energy and low environmental burden overall, and can efficiently obtain highly purified water M that can be discharged into rivers and the like.

### Fourth Embodiment

A fourth embodiment relates to tertiary amine compounds. The tertiary amine compound of the fourth embodiment is the amine compound of (2-3) in FIG. 4. The tertiary amine compound of (2-3) is preferably used for the water treatment of the first to third embodiments. The amine compound of (2-3) is included in amine solution C of the first to third embodiments of water treatment.

An example of the synthesis process of the amine compound in FIG. 4 (2-3) is described below. Dibromopropane and THF (tetrahydrofuran) are mixed, and 4 equivalents of calcium carbonate to dibromopropane are added. Further, 4 equivalents of methyl-1-piperazine carboxylate are added to the dibromopropane. The mixture is stirred at 70[° C.] for 24 hours and then filtered under reduced pressure. The filtrate is concentrated to obtain the composition. The composition is purified by silica gel chromatography (chloroform/methanol) to obtain the compound of the chemical formula (2-3).

Hereinafter, examples of embodiments will be described.

### (Example 1) Chemical Formula (1-2) (Salt Concentrate)

10 [wt %] NaCl solution and the amine compound of the chemical formula (1-2) are placed in a graduated cylinder with a stopper. The mixture is then stoppered and stirred at room temperature and allowed to stand. The volume is adjusted so that the volume ratio of solvent to treated water (solvent/feed) is 4.0. Because of phase-separation, the supernatant liquid is transferred to another glass container. The Cl concentration of the supernatant is measured by ion chromatography, and a salt removal rate is found to be 97 [%]. The salt removal rate is calculated using the following equation.

Salt Removal Rate={(NaCl input amount)−(NaCl concentration of supernatant solution)}/(NaCl input amount)×100

The salt concentration of the concentrate separated in the lower phase is measured to be 21.0 [wt %], which is close to that of saturated salt water. The volume of the lower phase is 52 [%] of the volume of the input aqueous phase.

When the separated supernatant solution is heated in a thermostatic bath at 70[° C.], it is separated into an amine phase and an aqueous phase. When the amine phase is separated and used for the same test, the salt removal rate of 97.5 [%] is obtained, and the concentration of the lower phase being separated of 21.2 [wt %] is obtained, which is the similar results as in the first test.

### (Example 2) Chemical Formula (1-2) (Salt Concentrate)

10 [wt %] NaCl solution and the amine compound of the chemical formula (1-2) are placed in a graduated cylinder with a stopper. The mixture is then stoppered and stirred at room temperature and allowed to stand. The volume is adjusted so that the volume ratio of solvent to treated water (solvent/feed) is 6.0. Because of phase separation, the supernatant liquid is transferred to another glass container. The Cl concentration of the supernatant is measured by ion chromatography, and the salt removal rate is found to be 98.7 [%].

The salt concentration of the concentrate separated in the lower phase is measured to be 25.9 [wt %], which is close to that of saturated salt water. The volume of the lower phase is 54 [%] of the volume of the input aqueous phase.

When the separated supernatant solution is heated in a thermostatic bath at 70[° C.], it is separated into an amine phase and an aqueous phase. When the amine phase is separated and used for the same test, the salt removal rate of 98.5 [%] is obtained, and the concentration of the lower phase being separated of 25.9 [wt %] is obtained, which is the similar results as in the first test.

### (Example 3) Chemical Formula (1-2) (Salt Precipitation)

10 [wt %] NaCl solution and the amine compound of the chemical formula (1-2) are placed in a graduated cylinder with a stopper. The mixture is then stoppered and stirred at room temperature and allowed to stand. The volume is adjusted so that the volume ratio of solvent to treated water (solvent/feed) is 7.0. Because salt is precipitated and deposited, the supernatant liquid is transferred to another glass container. The Cl concentration of the supernatant is measured by ion chromatography, and the salt removal rate is found to be 99.0 [%].

When the separated supernatant solution is heated in a thermostatic bath at 60[° C.], it is separated into an amine phase and an aqueous phase. When the amine phase is separated and used for the same test, the salt removal rate of 99.2 [%] is obtained, which the similar results as in the first test.

### (Example 4) Chemical Formula (1-2) (Salt Precipitation)

10 [wt %] NaCl solution and the amine compound of the chemical formula (1-2) are placed in a graduated cylinder with a stopper. The mixture is then stoppered and stirred at room temperature and allowed to stand. The volume is adjusted so that the volume ratio of solvent to treated water (solvent/feed) is 10.0. Because salt is precipitated and deposited, the supernatant liquid is transferred to another glass container. The Cl concentration of the supernatant is measured by ion chromatography, and the salt removal rate is found to be 99.0 [%].

When the separated supernatant solution is heated in a thermostatic bath at 70[° C.], it is separated into an amine phase and an aqueous phase. When the amine phase is separated and used for the same test, the salt removal rate of 99.0 [%] is obtained, which the similar results as in the first test.

### (Example 5) Chemical Formula (2-1)

The same test as in Example 1 is performed except that the amine compound of the chemical formula (2-1) is used. The Cl concentration of the supernatant is measured by ion chromatography, and the salt removal rate is found to be 96.5 [%]. The salt concentration of the concentrate separated in the lower phase is measured to be 22.0 [wt %].

When the separated supernatant solution is heated in a thermostatic bath at 70[° C.], it is separated into an amine phase and an aqueous phase. When the amine phase is separated and used for the same test, the salt removal rate of 97.5 [%] is obtained, and the concentration of the lower phase being separated of 21.2 [wt %] is obtained, which is the similar results as in the first test.

### (Example 6) Chemical Formula (2-1)

The same test as in Example 2 is performed except that the amine compound of chemical formula (2-1) is used. The Cl concentration of the supernatant is measured by ion chromatography, and the salt removal rate is found to be 98.3 [%].

The salt concentration of the concentrate separated in the lower phase is measured to be 25.5 [wt %], which is close to that of saturated salt water. The volume of the lower phase is 50 [%] of the volume of the input aqueous phase.

When the separated supernatant solution is heated in a thermostatic bath at 70[° C.], it is separated into an amine phase and an aqueous phase. When the amine phase is separated and used for the same test, the salt removal rate of 99.0 [%] is obtained, and the concentration of the lower phase being separated of 25.3 [wt %] is obtained, which is the similar results as in the first test.

### (Example 7) Chemical Formula (2-1)

The same test as in Example 3 is performed except that an amine compound of chemical formula (2-1) is used and the temperature for the phase-separation is 50[° C.]. Because salt is precipitated and deposited, the supernatant liquid is transferred to another glass container. The Cl concentration of the supernatant is measured by ion chromatography, and the salt removal rate is found to be 98.3 [%].

When the separated supernatant solution is heated in a thermostatic bath at 50[° C.], it is separated into an amine phase and an aqueous phase. When the amine phase is separated and used for the same test, the salt removal rate of 99.2 [%] is obtained, which the similar results as in the first test.

### (Example 8) Chemical Formula (2-1)

The same test as in Example 4 is performed except that the amine compound of chemical formula (2-1) is used. Because salt is precipitated and deposited, the supernatant liquid is transferred to another glass container. The Cl concentration of the supernatant is measured by ion chromatography, and the salt removal rate is found to be 99.0 [%].

When the separated supernatant solution is heated in a thermostatic bath at 70[° C.], it is separated into an amine phase and an aqueous phase. When the amine phase is separated and used for the same test, the salt removal rate of 99.0 [%] is obtained, which the similar results as in the first test.

### Comparative Example 1

10 [wt %] NaCl solution and diisopropylamine are placed in a graduated cylinder with a stopper. The mixture is then stoppered and stirred at room temperature and allowed to stand. The volume is adjusted so that the volume ratio of solvent to treated water (solvent/feed) is 4.0. Because of phase-separation, the supernatant liquid is transferred to another glass container. The salt concentration of the concentrate separated in the lower phase is measured to be 15.0 [wt %]

### Comparative Example 2

10 wt % NaCl solution and diisopropylamine are placed in a graduated cylinder with a stopper. The mixture is then stoppered and stirred at room temperature and allowed to stand. The volume is adjusted so that the volume ratio of solvent to treated water (solvent/feed) is 10.0. Because of phase-separation, the supernatant liquid is transferred to another glass container. The salt concentration of the concentrate separated in the lower phase is measured to be 24.0 [wt %].

### Comparative Example 3

10 [wt %] NaCl solution and diisopropylamine are placed in a graduated cylinder with a stopper. The mixture is then stoppered and stirred at room temperature and allowed to stand. The volume is adjusted so that the volume ratio of solvent to treated water (solvent/feed) is 15.0. Because of phase-separation, the supernatant liquid is transferred to another glass container. The salt concentration of the concentrate separated in the lower phase is measured to be 25.9 [wt %]

### Comparative Example 4

10 [wt %] NaCl solution and polypropylene glycol (Average Mn ˜725) are placed in a graduated cylinder with a stopper. The mixture is then stoppered and stirred at room temperature and allowed to stand. The volume is adjusted so that the volume ratio of solvent to treated water (solvent/feed) is 10.0. Because of phase separation, the supernatant liquid is transferred to another glass container. The salt concentration of the concentrate separated in the lower phase is measured to be 10.0 [wt %]

### Comparative Example 5

10 [wt %] NaCl solution and polypropylene glycol (Average Mn ˜725) are placed in a graduated cylinder with a stopper. The mixture is then stoppered and stirred at room temperature and allowed to stand. The volume is adjusted so that the volume ratio of solvent to treated water (solvent/feed) is 14.0. Because of phase-separation, the supernatant liquid is transferred to another glass container. The salt concentration of the concentrate separated in the lower phase is measured to be 14.0 [wt %]

### Comparative Example 6

10 [wt %] NaCl solution and polypropylene glycol (Average Mn ˜725) are placed in a graduated cylinder with a stopper. The mixture is then stoppered and stirred at room temperature and allowed to stand. The volume is adjusted so that the volume ratio of solvent to treated water (solvent/feed) is 15.0. Because of phase-separation, the supernatant liquid is transferred to another glass container. The salt concentration of the concentrate separated in the lower phase is measured to be 22.0 [wt %].

TABLE 1

| | | | | | Salt | | Separating |
|---|---|---|---|---|---|---|---|
| | | | Salt | Salt | Concentration | | Temperature |
| | | | Removal | Removal | of Concentrate | Concentration/ | Water/Amine |
| | Amine | S/F | Rate 1 | Rate 2 | (%) | Precipition | [° C.] |
| Example 1 | 1-2 | 4.0 | 97.0 | 97.5 | 21.0 | Concentration | 70.0 |
| Example 2 | 1-2 | 6.0 | 98.7 | 98.5 | 25.9 | Concentration | 70.0 |
| Example 3 | 1-2 | 7.0 | 99.0 | 99.2 | — | Precipition | 60.0 |
| Example 4 | 1-2 | 10.0 | 99.0 | 99.0 | — | Precipition | 70.0 |
| Example 5 | 2-1 | 4.0 | 97.0 | 97.5 | 21.0 | Concentration | 70.0 |
| Example 6 | 2-1 | 6.0 | 98.7 | 98.5 | 25.9 | Concentration | 70.0 |
| Example 7 | 2-1 | 7.0 | 99.0 | 99.2 | — | Precipition | 50.0 |
| Example 8 | 2-1 | 10.0 | 99.0 | 99.0 | — | Precipition | 70.0 |
| Comparative | diisopropylamine | 4.0 | — | | 15.0 | Concentration | — |
| Example 1 | | | | | | | |
| Comparative | diisopropylamine | 10.0 | — | | 24.0 | Concentration | — |
| Example 2 | | | | | | | |
| Comparative | diisopropylamine | 15.0 | — | | 25.9 | Concentration | — |
| Example 3 | | | | | | | |
| Comparative | polypropylene glycol | 4.0 | — | | 10.0 | Concentration | — |
| Example 4 | | | | | | | |
| Comparative | polypropylene glycol | 10.0 | — | | 14.0 | Concentration | — |
| Example 5 | | | | | | | |
| Comparative | polypropylene glycol | 15.0 | — | | 22.0 | Concentration | — |
| Example 6 | | | | | | | |

The results show that salt from an aqueous solution containing salt can be efficiently concentrated with a small amount of solvent by using the tertiary amine compound whose compatibility with water changes with heat. The salt concentration of the water concentrated by the dissolution of tertiary amine compounds in treated water A, the amount of extracted salt, and the amount of the tertiary amine compound required for concentration differ. This is thought to depend on the structure, solubility and polarity of the amine compound. The supernatant solution after extraction of salts can be heated to separate water and the tertiary amine compound, and the tertiary amine compound and water can be recovered. The supernatant solution after extraction of salts can be heated to separate water and the tertiary amine compound, and the tertiary amine compound and water can be recovered. Since the aqueous phase after phase-separation also contains the amine compound, highly purified water can be obtained by the RO membrane treatment. In the example using the amine compound of the embodiment, a concentrated phase (liquid phase (concentration shown in table) or solid phase (precipitation shown in table)) is obtained from a small amount. Even when the S/F is less than 7, the salt removal rate is high, and the amine compound of the embodiment is highly practical.

In the examples, some unmeasured results are hyphenated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Hereinafter, clauses of embodiments are additionally noted.

### Clause 1

A water treatment system comprising:
an element that introduces treated water into a first container;
an element that introduces an amine solution into the first container to obtain a first mixture; and
an element that separates a supernatant phase and a concentrated phase of a second mixture in which the first mixture is phase-separated, wherein
the amine solution includes one or more tertiary amine compounds represented by a chemical formula (1) or/and a chemical formula (2),
R¹ in the chemical formula (1) is a linear alkyl chain having 2 or more and 4 or less carbon atoms,
R² in the chemical formula (2) is a linear alkyl chain having 2 or more and 4 or less carbon atoms,
R³ in the chemical formula (2) is a linear alkyl group having 1 or more and 4 or less carbon atoms or a branched alkyl group having 3 or 4 carbon atoms, and
R⁴ in the chemical formula (2) is a linear alkyl group having 1 or more and 4 or less carbon atoms or a branched alkyl group having 3 or 4 carbon atoms.

### Clause 2

The water treatment system according to clause 1, wherein
R² in the chemical formula (2) is a linear alkyl chain having 2 or more and 4 or less carbon atoms, and
R³ and R⁴ are the same and are linear alkyl groups each having 1 or more and 4 or less carbon atoms or branched alkyl groups each having 3 or 4 carbon atoms.

### Clause 3

The water treatment system according to clause 1 or 2, wherein
R² in the chemical formula (2) is a linear alkyl chain having 2 or 3 carbon atoms, and
R³ and R⁴ are the same and are linear alkyl groups each having 1 or more and 3 or less carbon atoms or branched alkyl groups each having 3 or 4 carbon atoms.

### Clause 4

The water treatment system according to any one of clauses 1 to 3, wherein
R² in the chemical formula (2) is a linear alkyl chain having 2 or 3 carbon atoms, and
R³ and R⁴ are the same and are linear alkyl groups each having 1 or more and 3 or less carbon atoms or branched alkyl groups each having 3 carbon atoms.

### Clause 5

The water treatment system according to any one of clauses 1 to 4, wherein
R² in the chemical formula (2) is a linear alkyl chain having 3 carbon atoms, and
R³ and R⁴ are the same and are linear alkyl groups each having 1 or more and 3 carbon atoms.

### Clause 6

The water treatment system according to any one of clauses 1 to 5, wherein
the amine compound of the chemical formula (1) is one or more compounds selected from the group consisting of a tertiary amine compound of the chemical formula (1-1), a tertiary amine compound of the chemical formula (1-2), and a tertiary amine compound of the chemical formula (1-3).

### Clause 7

The water treatment system according to any one of clauses 1 to 6, wherein
the amine compound of the chemical formula (2) is one or more compounds selected from the group consisting of a tertiary amine compound of the chemical formula (2-1), a tertiary amine compound of the chemical formula (2-2), and a tertiary amine compound of the chemical formula (2-3).

### Clause 8

The water treatment system according to any one of clauses 1 to 7, wherein
the amine solution includes 80 [wt %] or more and 100 [wt %] or less of the tertiary amine compound of the chemical formula (1) or/and the chemical formula (2).

### Clause 9

The water treatment system according to any one of clauses 1 to 8, wherein
where the volume of the treated water is 1, the volume of the amine solution is 4 or more and 100 or less.

### Clause 10

The water treatment system according to any one of clauses 1 to 9, wherein
where the volume of the treated water is 1, the volume of the amine solution is 4 or more and 25 or less.

### Clause 11

The water treatment system according to any one of clauses 1 to 9, wherein
a phase of the first mixture separates at 3[° C.] or more and 40[° C.] or less.

### Clause 12

A water treatment method comprising:
obtaining a first mixture by mixing treated water and amine solution;
obtaining a second mixture which is phase-separated by separating the first mixture; and
separating a supernatant phase and a concentrated phase of the second mixture, wherein
the amine solution includes one or more tertiary amine compounds represented by a chemical formula (1) or/and a chemical formula (2),
R¹ in the chemical formula (1) is a linear alkyl chain having 2 or more and 4 or less carbon atoms,
R² in the chemical formula (2) is a linear alkyl chain having 2 or more and 4 or less carbon atoms,
R³ in the chemical formula (2) is a linear alkyl group having 1 or more and 4 or less carbon atoms or a branched alkyl group having 3 or 4 carbon atoms, and
R⁴ in the chemical formula (2) is a linear alkyl group having 1 or more and 4 or less carbon atoms or a branched alkyl group having 3 or 4 carbon atoms.

### Clause 13

The water treatment method according to clause 12, wherein
R² in the chemical formula (2) is a linear alkyl chain having 2 or more and 4 or less carbon atoms, and
R³ and R⁴ are the same and are linear alkyl groups each having 1 or more and 4 or less carbon atoms or branched alkyl groups each having 3 or 4 carbon atoms.

### Clause 14

The water treatment method according to clause 12 or 13, wherein
R² in the chemical formula (2) is a linear alkyl chain having 2 or 3 carbon atoms, and
R³ and R⁴ are the same and are linear alkyl groups each having 1 or more and 3 or less carbon atoms or branched alkyl groups each having 3 or 4 carbon atoms.

### Clause 15

The water treatment method according to any one of clauses 12 to 14, wherein
R² in the chemical formula (2) is a linear alkyl chain having 2 or 3 carbon atoms, and
R³ and R⁴ are the same and are linear alkyl groups each having 1 or more and 3 or less carbon atoms or branched alkyl groups each having 3 carbon atoms.

### Clause 16

The water treatment method according to any one of clauses 12 to 15, wherein
R² in the chemical formula (2) is a linear alkyl chain having 3 carbon atoms, and
R³ and R⁴ are the same and are linear alkyl groups each having 1 or more and 3 carbon atoms.

### Clause 17

The water treatment method according to any one of clauses 12 to 16, wherein
the amine compound of the chemical formula (1) is one or more compounds selected from the group consisting of a tertiary amine compound of the chemical formula (1-1), a tertiary amine compound of the chemical formula (1-2), and a tertiary amine compound of the chemical formula (1-3).

### Clause 18

The water treatment method according to any one of clauses 12 to 17, wherein
the amine compound of the chemical formula (2) is one or more compounds selected from the group consisting of a tertiary amine compound of the chemical formula (2-1), a tertiary amine compound of the chemical formula (2-2), and a tertiary amine compound of the chemical formula (2-3).

### Clause 19

The water treatment method according to any one of clauses 12 to 18, wherein
the amine solution includes 80 [wt %] or more and 100 [wt %] or less of the tertiary amine compound of the chemical formula (1) or/and the chemical formula (2).

### Clause 20

The water treatment method according to any one of clauses 12 to 19, wherein
where the volume of the treated water is 1, the volume of the amine solution is 4 or more and 100 or less.

### Clause 21

The water treatment method according to any one of clauses 12 to 20, wherein
where the volume of the treated water is 1, the volume of the amine solution is 4 or more and 25 or less.

### Clause 22

The water treatment method according to any one of clauses 12 to 21, wherein
a phase of the first mixture separates at 3[° C.] or more and 40[° C.] or less.

### Clause 23

The water treatment system according to any one of clauses 1 to 11, further comprising:
an element that separates the supernatant phase into an aqueous phase and an organic phase and recovers the tertiary amine, wherein
the supernatant phase separates into the aqueous phase and the organic phase at a higher temperature than the first mixture which separates into phases.

### Clause 24

The water treatment system according to clause 23, wherein
the supernatant phase is phase-separated into an aqueous phase and an organic phase at 35[° C.] or more and less than 90[° C.].

### Clause 25

The water treatment system according to clause 23 or 24, wherein
the supernatant phase is heated to a temperature 10[° C.] or higher than the temperature at which the first mixture is phase-separated.

### Clause 26

The water treatment method according to any one of clauses 12 to 22, further comprising:
separating the supernatant phase into the aqueous phase by heating and the organic phase and recovering the tertiary amine, wherein
   the supernatant phase separates into the aqueous phase and the organic phase at a higher temperature than the first mixture which separates into phases.

### Clause 27

The water treatment method according to clause 27, wherein
the supernatant phase is phase-separated into an aqueous phase and an organic phase at 35[° C.] or more and less than 90[° C.].

### Clause 28

The water treatment system according to clause 26 or 27, wherein
the supernatant phase is heated to a temperature 10[° C.] or higher than the temperature at which the first mixture is phase-separated.

### Clause 29

An amine solution comprising:
a tertiary amine compound represented by a chemical formula (2-3).

What is claimed is:

1. A water treatment system comprising:
an element that introduces treated water into a first container;
an element that introduces an amine solution into the first container to obtain a first mixture; and
an element that separates a supernatant phase and a concentrated phase of a second mixture in which the first mixture is phase-separated, wherein
the amine solution includes one or more tertiary amine compounds represented by a chemical formula (1) or/and a chemical formula (2),
R¹ in the chemical formula (1) is a linear alkyl chain having 2 or more and 4 or less carbon atoms,
R² in the chemical formula (2) is a linear alkyl chain having 2 or more and 4 or less carbon atoms,
R³ in the chemical formula (2) is a linear alkyl group having 1 or more and 4 or less carbon atoms or a branched alkyl group having 3 or 4 carbon atoms, and
R⁴ in the chemical formula (2) is a linear alkyl group having 1 or more and 4 or less carbon atoms or a branched alkyl group having 3 or 4 carbon atoms.

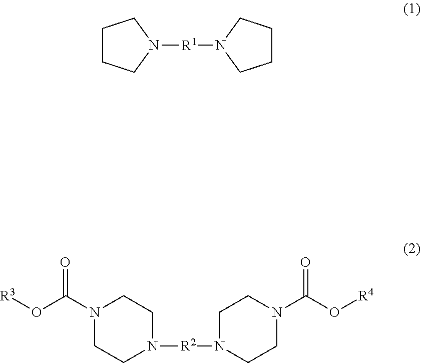

2. The water treatment system according to claim 1, wherein
R² in the chemical formula (2) is a linear alkyl chain having 2 or more and 4 or less carbon atoms, and
R³ and R⁴ are the same and are linear alkyl groups each having 1 or more and 4 or less carbon atoms or branched alkyl groups each having 3 or 4 carbon atoms.

3. The water treatment system according to claim 1, wherein
R² in the chemical formula (2) is a linear alkyl chain having 2 or 3 carbon atoms, and
R³ and R⁴ are the same and are linear alkyl groups each having 1 or more and 3 or less carbon atoms or branched alkyl groups each having 3 or 4 carbon atoms.

4. The water treatment system according to claim 1, wherein
R² in the chemical formula (2) is a linear alkyl chain having 2 or 3 carbon atoms, and
R³ and R⁴ are the same and are linear alkyl groups each having 1 or more and 3 or less carbon atoms or branched alkyl groups each having 3 carbon atoms.

5. The water treatment system according to claim 1, wherein
R² in the chemical formula (2) is a linear alkyl chain having 3 carbon atoms, and
R³ and R⁴ are the same and are linear alkyl groups each having 1 or more and 3 carbon atoms.

6. The water treatment system according to claim 1, wherein
the amine compound of the chemical formula (1) is one or more compounds selected from the group consisting of a tertiary amine compound of the chemical formula (1-1), a tertiary amine compound of the chemical formula (1-2), and a tertiary amine compound of the chemical formula (1-3).

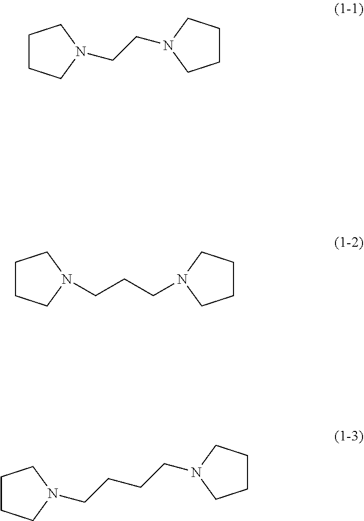 [SMILES: C1CCN(CCN2CCCC2)C1 ; C1CCN(CCCN2CCCC2)C1 ; C1CCN(CCCCN2CCCC2)C1]

7. The water treatment system according to claim 1, wherein
the amine compound of the chemical formula (2) is one or more compounds selected from the group consisting of a tertiary amine compound of the chemical formula (2-1), a tertiary amine compound of the chemical formula (2-2), and a tertiary amine compound of the chemical formula (2-3).

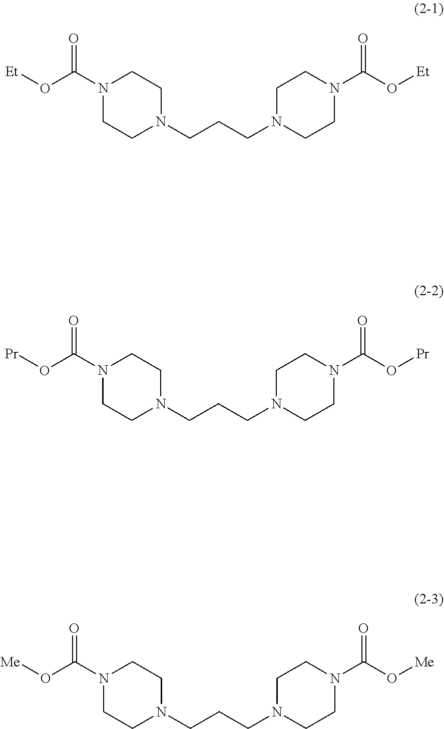

8. The water treatment system according to claim 1, wherein
the amine solution includes 80 [wt %] or more and 100 [wt %] or less of the tertiary amine compound of the chemical formula (1) or/and the chemical formula (2).

9. The water treatment system according to claim 1, wherein
where the volume of the treated water is 1, the volume of the amine solution is 4 or more and 100 or less.

10. The water treatment system according to claim 1, wherein
where the volume of the treated water is 1, the volume of the amine solution is 4 or more and 25 or less.

11. The water treatment system according to claim 1, wherein
a phase of the first mixture separates at 3[° C.] or more and 40[° C.] or less.

12. The water treatment system according to claim 1, wherein
the amine solution includes one or more tertiary amine compounds represented by a chemical formula (1) and a chemical formula (2).

13. A water treatment method comprising:
obtaining a first mixture by mixing treated water and amine solution;
obtaining a second mixture which is phase-separated by phase-separating the first mixture; and
separating a supernatant phase and a concentrated phase of the second mixture, wherein
the amine solution includes one or more tertiary amine compounds represented by the chemical formula (1) or/and the chemical formula (2) according to claim 1.

14. The water treatment method according to claim 13, wherein
a phase of the first mixture separates at 3[° C.] or more and 40[° C.] or less.

15. The water treatment system according to claim 1, further comprising:
an element that separates the supernatant phase into an aqueous phase and an organic phase and recovers the tertiary amine, wherein
the supernatant phase separates into the aqueous phase and the organic phase at a higher temperature than the first mixture which separates into phases.

16. The water treatment system according to claim 15, wherein
the supernatant phase is phase-separated into an aqueous phase and an organic phase at 35[° C.] or more and less than 90[° C.].

17. The water treatment method according to claim 13, further comprising:
separating the supernatant phase into the aqueous phase by heating and the organic phase and recovering the tertiary amine, wherein
the supernatant phase separates into the aqueous phase and the organic phase at a higher temperature than the first mixture which separates into phases.

18. The water treatment method according to claim 17, wherein
the supernatant phase is phase-separated into an aqueous phase and an organic phase at 35[° C.] or more and less than 90[° C.].

19. An amine solution comprising:
a tertiary amine compound represented by a chemical formula (2-3). 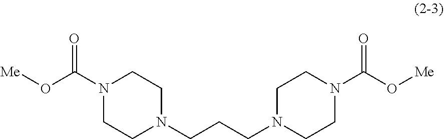 [SMILES: COC(=O)N1CCN(CCCN2CCN(C(=O)OC)CC2)CC1]
